(19) United States
(12) Patent Application Publication
(10) Pub. No.: US 2016/0226686 A1
(43) Pub. Date: Aug. 4, 2016

(54) RECEIVING APPARATUS AND RECEIVING METHOD

(71) Applicant: LAPIS Semiconductor Co., Ltd., Yokohama (JP)

(72) Inventor: Takamitsu HAFUKA, Yokohama (JP)

(73) Assignee: LAPIS Semiconductor Co., Ltd., Yokohama (JP)

(21) Appl. No.: 15/009,750

(22) Filed: Jan. 28, 2016

(30) Foreign Application Priority Data
Jan. 29, 2015 (JP) 2015-015316

(51) Int. Cl. H04L 27/152; H04L 27/26

(52) U.S. Cl. CPC H04L 27/1525; H04L 27/2655; H04L 2027/0028

(57) ABSTRACT

An LPF eliminates noise components from baseband signal obtained by performing a frequency conversion on the received signal on the basis of the received wireless transmission wave. A passband setting part sets the upper limit of frequency of passband in the LPF at a high frequency while a synchronization signal is not detected and at a low frequency after a synchronization signal is detected.

### BACKGROUND OF THE INVENTION

1. Field of the Invention

The present invention relates to a receiving apparatus, in particular to a receiving apparatus for receiving and demodulating a wireless transmission wave, and to a receiving method for receiving the wireless transmission wave.

2. Description of the Related Art

A receiving apparatus has been proposed which employs a so-called FSK (Frequency Shift Keying) scheme as a digital modulation scheme used in a specified low power radio systems (For example, Japanese patent application Laid-Open No. H09-162936). Such receiving apparatus includes a mixer, a local oscillator, a filter such as a low-pass filter (referred to as “LPF” in the following description) and a demodulator. The mixer generates an intermediate frequency signal by mixing a received signal received by an antenna and a local oscillation signal generated in the local oscillator. The LPF eliminates noise components from the intermediate frequency signal. The demodulator demodulates information data such as audio, video and text on the basis of desired frequency components in the intermediate frequency signal from which the noise components are eliminated by the LPF.

In mobile communications, the receiving apparatus deals with a carrier signal which has relatively high frequency. Therefore, the local oscillator is desired to generate the local oscillation signal with high frequency and high stability. However, certain amount of frequency deviations occur in the local oscillation signal, even if the local oscillator with high stability is used. The amount of the frequency deviations become larger when using a relatively inexpensive oscillator, for example a crystal oscillator. The frequency deviations also occur in the intermediate frequency signal.

Therefore, the receiving apparatus includes a frequency offset correction means which detects the frequency deviations occurring in the intermediate frequency signal from which the noise components are eliminated by the LPF and corrects the frequency offset corresponding to the detected frequency deviation.

### SUMMARY OF THE INVENTION

The LPF might eliminate signal components in the desired band to be received, when relatively large frequency offset occurs. At this time, the frequency offset cannot be detected in a frequency detector provided in the latter part of the LPF. However, if the passband of the LPF is broadened, the amount of noises which pass through the LPF increases. For this reason, there occurs a problem that the reception sensitivity is reduced.

It is an object of the present invention to provide a receiving apparatus and a receiving method capable of good reception in which the frequency offset is eliminated without declining of reception sensitivity.

The receiving apparatus for demodulating a received signal obtained by receiving a wireless transmission wave which is modulated according to a series of data sequences including frames each having a synchronization signal, the receiving apparatus comprising:

a frequency converting part for performing a frequency conversion on the received signal and obtaining a frequency converted signal including a baseband signal,

a filter for eliminating high frequency noise components from the frequency converted signal and obtaining a high frequency noise eliminated signal,

a frequency detector for performing a frequency detection on the high frequency noise eliminated signal and obtaining a frequency detection signal,

a frequency offset detector for detecting a frequency offset occurring in the frequency converted signal on the basis of the frequency detection signal,

a frequency correction part for sifting frequency of the frequency converted signal by the amount of the frequency offset,

a synchronization detector for detecting the presence of the synchronization signal in each of said frames, and generating a synchronization detection signal which has a first level as far as the synchronization signal is not detected and has a second level when and after the synchronization signal is detected; and

a passband setting part for setting an upper limit of frequency of a passband in the filter at a lower frequency within a time period in which the synchronization detection signal is kept at the second level than that within a time period in which the synchronization detection signal is kept at the first level.

A receiving method according to the present invention is a receiving method for a receiving apparatus comprising a frequency converting part for performing a frequency conversion on the received signal and obtaining a frequency converted signal including a baseband signal, a filter for eliminating high frequency noise components from the frequency converted signal and obtaining a high frequency noise eliminated signal, a frequency detector for performing a frequency detection on the high frequency noise eliminated signal and obtaining a frequency detection signal, and a frequency offset detector for detecting a frequency offset occurring in the frequency converted signal on the basis of the frequency detection signal, the receiving method comprising the steps of:

detecting the presence of the synchronization signal in each frame, and generating a synchronization detection signal which has a first level as far as the synchronization signal is not detected and has a second level when and after the synchronization signal is detected,

setting an upper limit of frequency of a passband in the filter at lower frequency within a time period in which the synchronization detection signal is kept at the second level than that within a time period in which the synchronization detection signal is kept at the first level.

In the present invention, the LPF eliminates the noise components from the frequency converted signal obtained by performing a frequency conversion on received signal which is the result of receiving wireless transmission wave. The passband width of the LPF is set at broadband, i.e. the upper limit of frequency is high, during a period in which the synchronization signal is not detected. The passband width of the LPF is set at narrowband, i.e. the upper limit of frequency is low, after the synchronization signal is detected.

Since the passband width of the LPF is broadened until the synchronization signal is detected, the frequency offset is not eliminated in the LPF even if a large frequency offset occurs. Therefore, the frequency offset detector provided in the latter part of the LPF can detect the frequency offset and can perform a frequency correction on the basis of the detected frequency offset. On the other hand, after the synchronization signal is detected, it is possible to eliminate noises superimposed on the frequency converted signal including a baseband signal because the passband width of the LPF is narrowed. Therefore, it is possible to demodulate user data in a high reception sensitivity.

According to the present invention, it is possible to receive signals while eliminating the frequency offset without declining reception sensitivity.

### BRIEF DESCRIPTION OF THE DRAWINGS

Some aspects and other features of the present invention are explained in the following description, taken in connection with the accompanying drawing figures wherein:

FIG. 1 is a block diagram showing a configuration of a receiving apparatus 100;

FIG. 2 is a graph showing a frequency characteristic L1 and a frequency characteristic L2 in a LPF 15;

FIGS. 3A-3E are time charts respectively showing wave variations of signals appearing in the receiving apparatus 100;

FIG. 4 is a graph showing in comparison reception characteristic J1 when reproducing user data and reception characteristic J2 when reproducing a preamble;

FIG. 5 is a block diagram showing an example of the inner configuration of the LPF;

FIG. 6 is a block diagram showing an example of the inner configuration of a passband setting part 30; and

FIGS. 7A-7H are time charts respectively showing wave variations of signals appearing in the passband setting part 30.

### DETAILED DESCRIPTION OF THE INVENTION

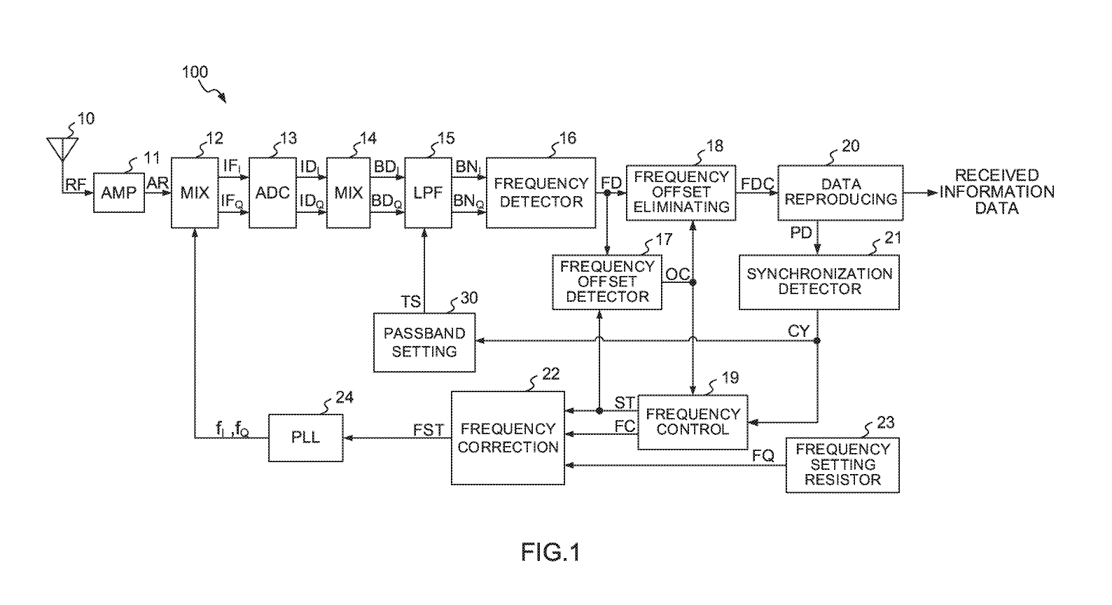

FIG. 1 is a block diagram showing an entire configuration of a receiving apparatus 100 according to the present invention.

An antenna 10 receives a wireless transmission wave which is transmitted from a transmission apparatus (not shown). The antenna 10 supplies an amplifier which may be a low noise amplifier with a high frequency signal RF on the basis of the wireless transmission wave as illustrated in FIG. 1. The wireless transmission wave is modulated in frequency in accordance with data sequences. Each frame of the data sequences comprises a preamble part consisting of a specific bit pattern representing a synchronization signal, a synchronization word representing a leading position of a user data piece, the user data pieces representing such information as audio, video and text. A digital modulation such as FSK is used as a modulation scheme in the modulation.

An amplifier 11 supplies a mixer 12 with a received signal AR obtained by amplifying the high frequency signal RF.

The mixer 12 converts the received signal AR into an intermediate frequency signal IFI which is corresponding to I-phase components in an intermediate frequency band by mixing a local oscillation signal fI in the received signal AR. The mixer 12 further converts the received signal AR into an intermediate frequency signal IFQ which is corresponding to Q-phase components in the intermediate frequency band by mixing a local oscillation signal fQ whose phase is shifted 90 degrees with respect to the local oscillation signal FI in the received signal AR. The mixer 12 supplies an A/D converter 13 with these intermediate frequency signals IFI and IFQ.

The A/D converter 13 supplies a mixer 14 with an intermediate frequency data signal IDI obtained by converting the intermediate frequency signal IFI and an intermediate frequency data signal IDQ obtained by converting the intermediate frequency signal IFQ.

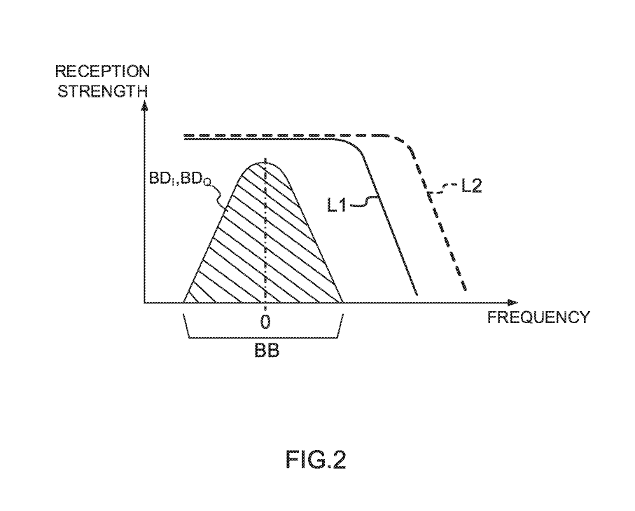

The mixer 14 performs a frequency conversion on the intermediate frequency data signal IDI into a baseband BB centering on the frequency 0 [Hz] and generates a frequency converted signal including a baseband signal BDI. The mixer 14 then supplies a LPF 15 with the frequency converted signal as illustrated in FIG. 2. The mixer 14 further performs the frequency conversion on the intermediate frequency data signal IDQ into the baseband BB centering on the frequency 0 [Hz] and generates a frequency converted signal including a baseband signal BDQ. The mixer 14 then supplies the LPF 15 with the frequency converted signal.

The LPF 15 is a filter that passes only signal components in a predetermined passband. The LPF 15 is explained as a low-pass filter in the following description. The LPF 15 passes only low frequency components in each of the frequency converted signals including the baseband signals BDI and BDQ, the frequency of which are equal to or less than a frequency range including the baseband BB which is illustrated in FIG. 2. As a result, the LPF 15 supplies a frequency detector 16 with high frequency noise eliminated signals BNI and BNQ. The high frequency noise eliminated signals BNI and BNQ are obtained by eliminating noise components having higher frequency than the frequency range.

The LPF 15 is the low-pass filter in which a cutoff frequency can be changed, that is, in which the passband width can be changed on the basis of a passband setting signal TS. The LPF 15 is set to a frequency characteristic having a passband width indicated by the passband setting signal TS. The LPF 15 passes the low components in each of the frequency converted signals including the baseband signals BDI and BDQ according to the frequency characteristic. Therefore, when the passband setting signal TS is a narrowband signal, the LPF 15 passes low frequency components in each of the frequency converted signals including the baseband signals BDI and BDQ, for example, according to a frequency characteristic L1 which is illustrated in FIG. 2. In addition, when the passband setting signal TS is a broadband signal, the LPF 15 passes low frequency components in each of the frequency converted signals including the baseband signals BDI and BDQ according to a frequency characteristic L2 in which the passband is broader in a high frequency side than that in the frequency characteristic L1, as illustrated in FIG. 2.

The frequency detector 16 supplies a frequency offset detector 17 and a frequency offset eliminating part 18 with a frequency detection signal FD obtained by converting changes of frequency into changes of amplitude in the high frequency noise eliminated signals BNI and BNQ.

The frequency offset detector 17 detects a frequency offset occurs in the frequency converted signals including the baseband signals (BDI, BDQ) and the intermediate frequency signals (IFI, IFQ) on the basis of the frequency detection signal FD. The frequency offset detector 17 supplies the frequency offset eliminating part 18 and a frequency control part 19 with an offset correction signal OC having a level corresponding to an amount of the detected frequency offset. The frequency offset represents deviations of the frequency of the intermediate frequency signal (IFI, IFQ) with respect to the reference frequency.

The frequency offset detector 17 initializes the level of the frequency offset correction signal OC to zero at a timing of a leading edge of the frequency control start signal ST indicating the initiation of the frequency control.

The frequency offset eliminating part 18 eliminates the frequency offset occurring in the frequency detection signal FD on the basis of the offset correction signal OC. The frequency offset eliminating part 18 sifts a level of the frequency detection signal FD by the amount of the frequency offset indicated by the offset correction signal OC. As a result, the frequency offset eliminating part 18 generates a frequency detection signal FDC by eliminating the frequency offset which is occurring in the frequency detection signal FD. The frequency offset eliminating part 18 supplies a data reproducing part 20 with the frequency detection signal FDC.

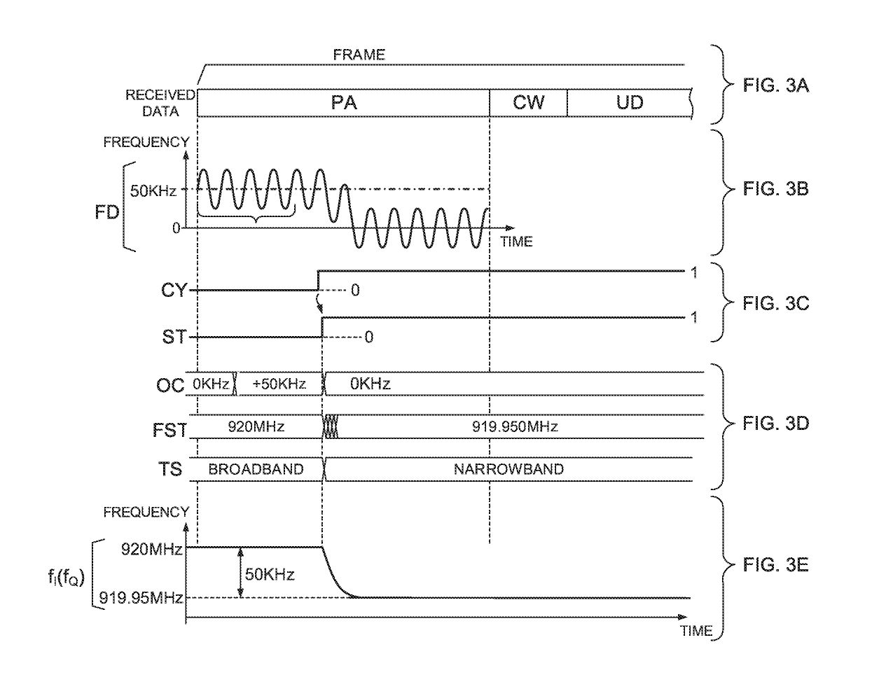

The data reproducing part 20 detects an appropriate symbol timing on the basis of the frequency detection signal FDC. The data reproducing part 20 demodulates the frequency detection signal FDC at the symbol timing. As a result, The data reproducing part 20 reproduces, at each frame, a preamble PA which includes a specific bit pattern representing a synchronization signal, a synchronization word CW which represents a leading (starting) point of a user data UD, and received data which includes the user data UD as illustrated in FIG. 3A.

The data reproducing part 20 detects the leading (starting) point of the user data UD by detecting the synchronization word CW from the frequency detection signal FDC. The data reproducing part 20 performs a predetermined demodulation processing and the error correction processing in order on the frequency detection signal FDC from the leading point. By performing these processes, the data reproducing part 20 reproduces information data such as audio, video and text represented by the user data UD. The data reproducing part 20 outputs the information data as a received information data.

The data reproducing part 20 reproduces a data bit sequence which is corresponding to the preamble PA illustrated in FIG. 3A by the demodulation processing on the frequency detection signal FDC. The data reproducing part 20 supplies a synchronization detector 21 with a preamble data PD which indicates the data bit sequence.

The synchronization detector 21 detects the specific bit pattern which is corresponding to the synchronization signal from the leading point to the tail point of the preamble data PD. The synchronization detector 21 generates a synchronization signal CY which is kept at logic level 0 during a period in which the specific bit pattern is not detected, and which is kept at logic level 1 during a period after which the specific bit pattern is detected.

In other words, the synchronization detector 21 generates the synchronization signal CY which is kept at logic level 0 during a period in which the synchronization signal included in the preamble PA illustrated in FIG. 3A and which makes transition from logic level 0 to level 1 when the synchronization signal is detected.

The synchronization detector 21 supplies the frequency control part 19 and a passband setting part 30 with the synchronization detection signal CY.

The frequency control part 19 supplies the frequency offset detector 17 and a frequency correction part 22 with the frequency control start signal ST which represents a time point of transition of the synchronization detection signal from logic level 0 to logic level 1, i.e. a time point of synchronization detection as illustrated in FIG. 3C.

The frequency control part 19 converts an offset amount which is represented by the offset correction signal OC into a frequency correction amount for the local oscillation signal (fI, fW). The frequency control part 19 supplies the frequency correction part 22 with a frequency correction signal FC which has a level corresponding to the frequency correction amount.

A frequency setting resistor 23 stores a reference frequency data FQ which indicates a reference frequency of the local oscillation signal. The frequency setting resistor 23 supplies the frequency correction part 22 with the reference frequency data FQ.

The frequency correction part 22 supplies a PLL (phase locked loop) circuit 24 with the frequency setting signal FST which indicates the reference frequency represented by the reference data FQ during a period in which the frequency control start signal ST is kept at logic level 0 as illustrated in FIG. 3C, i.e. a period in which the synchronization signal is not detected.

The frequency correction part 22 supplies the PLL circuit 24 with the frequency setting signal FST which indicates the correction frequency which is obtained by adding the frequency correction amount indicated by the frequency correction signal FC to the reference frequency indicated by the reference frequency data FQ, or by subtracting the frequency correction amount from the reference frequency, during a period in which the frequency control start signal ST is kept at logic level 1 as illustrated in FIG. 3C.

The PLL circuit 24 includes a phase detector, a loop filter, a voltage control oscillator, a divider and so on. The PLL circuit 24 generates the local oscillation signals fI and fQ having frequency represented by the frequency setting signal FST. The PLL circuit 24 supplies the mixer 12 with the local oscillation signals fI and fQ.

The passband setting part 30 supplies the LPF 15 with the passband setting signal TS which indicates broadband as first bandwidth during a period in which the synchronization detection signal CY is kept at logic level 0, i.e. a period in which the synchronization signal is not detected. The passband setting part 30 supplies the LPF 15 with the passband setting signal TS which indicates narrowband as second bandwidth during a period in which the synchronization detection signal CY is kept at logic level 1, i.e. a period after which the synchronization signal is detected.

It is described below with reference to a time chart which is illustrated in FIGS. 3A-3E, the operations of the receiving apparatus 100 having the above configuration. FIGS. 3A-3E shows examples of wave variations of signals appearing in operations of the receiving apparatus 100 when frequency gap occurs between the intermediate frequency signal IFI and IFQ at the leading point of the frame of the received data, in case that the reference frequency of the local oscillation signals fI and fQ are at 920 Hz.

Since the frequency control is not yet started in the leading point of each frame of the received data, the frequency of the local oscillation signals fI and fQ are set at 920 MHz which is the reference frequency. The frequency detection signal FD on which the frequency offset +50 kHz is superimposed can be obtained during a period which is corresponding to the preamble PA at the leading point of the frame, as illustrated in FIG. 3B. During this period, the frequency offset detector 17 supplies the frequency offset eliminating part 18 and the frequency offset control part 19 with the offset correction signal OC which indicates the frequency offset +50 kHz as illustrated in FIG. 3D. The frequency offset eliminating part 18 generates the frequency detection signal FDC from which the frequency offset is eliminated by shifting a level of the frequency detection signal FD lower by the amount corresponding to the frequency offset +50 kHz indicated by the offset correction signal OC.

According to such operations of the frequency offset elimination part 18, the frequency detection signal FDC which is centered on zero level is generated, before the frequency offset control part 19 starts frequency control processing. The operations of the frequency offset elimination part 18 makes it possible for the data reproducing part 20 to reproduce data while suppressing bit errors. The synchronization detection signal CY makes transition from logic level 0 to level 1 as illustrated in FIG. 3C when the synchronization signal represented by the specific bit pattern which is included in the preamble PA is detected. So as to follow the synchronization detection signal CY, the frequency control start signal ST makes transition from logic level 0 to logic level 1 as illustrated in FIG. 3C.

In response to the frequency control start signal ST at logic level 0, the frequency control part 19 takes in the offset correction signal OC. The frequency control part 19 supplies the frequency correction part 22 with the frequency correction signal FC which indicates the amount of the frequency correction corresponding to the amount of the offset correction (50 kHz) indicated by the offset correction signal OC. The frequency correction 22 supplies the PLL circuit 24 with the frequency setting signal FST which indicates a correction frequency (919.950 MHz) obtained by subtracting the amount of frequency correction indicated by the frequency correction signal FC from the reference frequency (920 MHz) indicated by the reference frequency data FQ. The frequency of the local oscillation signal fI and fQ generated by the PLL circuit 24 shifts from the initiation value 920 MHz to 919.950 MHz. As a result, the frequency gap between the intermediate frequency signal IFI and IFQ is eliminated. The frequency offset in the frequency detection signal FD gradually shifts to zero as illustrated in FIG. 3E.

The frequency offset detector 17 initializes a level of the offset correction signal OC to zero in response to the frequency control start signal ST which is at logic level 1. Since the frequency gap is eliminated by the frequency correction to the local oscillation signal, it is not required for the frequency offset eliminating part 18 to perform an offset eliminating process. The receiving apparatus 100 initializes the level of the offset correction signal OC to zero at a start timing of the frequency control in response to the frequency control start signal ST which is at logic level 1.

The passband setting part 30 supplies the LPF 15 with the passband setting signal TS representing the broadband during a period in which the synchronization signal CY is kept at logic level 0, i.e. a period in which the synchronization signal is not detected. The LPF 15 passes low frequency components in each of the frequency converted signals including the baseband signals BDI and BDQ with the frequency characteristic L2 which is broader than the frequency characteristic L1. Since the passband width of the LPF 15 is broadened, the frequency offset is not eliminated by the LPF 15 at the stage before the synchronization signal is detected in each frame, even if a large frequency offset occurs in the intermediate frequency signals IFI and IFQ. Therefore, the frequency offset detector 17 can detect relatively large offset such as described above. As a result, the frequency offset can be eliminated absolutely.

On the other hand, the passband setting part 30 supplies the LPF 15 with the passband setting signal TS indicating the narrowband when the synchronization detection signal CY is kept at logic level 1,i.e. after the synchronization signal is detected. As a result, the LPF 15 passes low frequency components in the frequency converted signal including the baseband signals BDI and BDQ with the frequency characteristic L1 which is narrower than the frequency characteristic L2, i.e. an upper limit of frequency of which is lower than that of the frequency characteristic L2 as illustrated in FIG. 2. In other words, the passband setting part 30 makes it possible for the LPF 15 to eliminate the noise superimposed on the intermediate frequency signals (IFI, IFQ) and the frequency converted signals including the baseband signals (BDI, BDQ) by making the passband width of the LPF 15 narrow after the synchronization signal is detected in each frame. As a result, it is possible to demodulate the user data UD with high reception sensitivity.

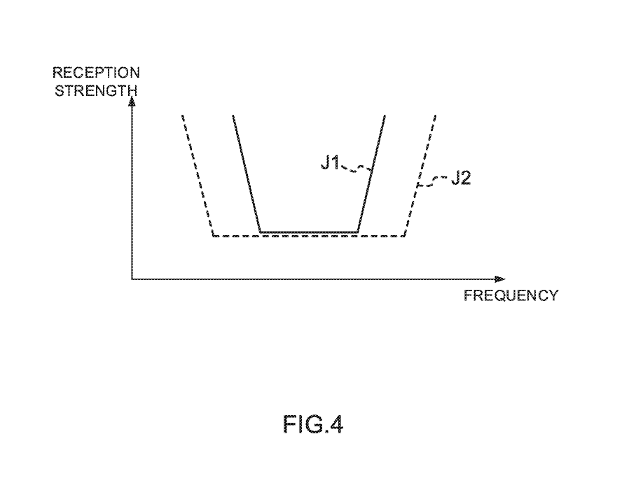

The reception sensitivity of the receiving apparatus 100 declines when the passband of the LPF 15 is the broadband, compared to when the passband of the LPF 15 is the narrowband. However, the specific bit pattern which represents the synchronization signal in the preamble PA is a pattern known in the receiving apparatus. Therefore, it is possible to determine bit series obtained by reproducing the preamble PA as the specific bit pattern, even if errors are mixed to the bit series. The reception characteristic J2 for a synchronization detection (preamble detection) which is necessary when reproducing the preamble PA is broader than the reception characteristic J1 which is necessary when reproducing the user data UD, as illustrated in FIG. 4. Therefore, it is possible to detect the synchronization signal without declining of reception sensitivity even if the bandwidth of the LPF 15 is broad.

The receiving apparatus 100 which is illustrated in FIG. 1 can receive signals while eliminating the frequency offset without declining of reception sensitivity.

A digital filter can be adopted to the LPF 15. In that case, the passband width can be changed by changing the frequency of the clock signal which is supplied to the digital filter.

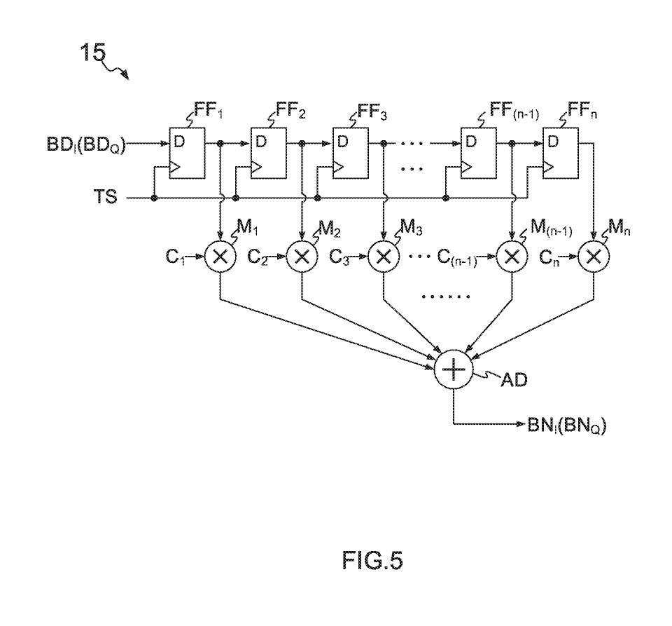

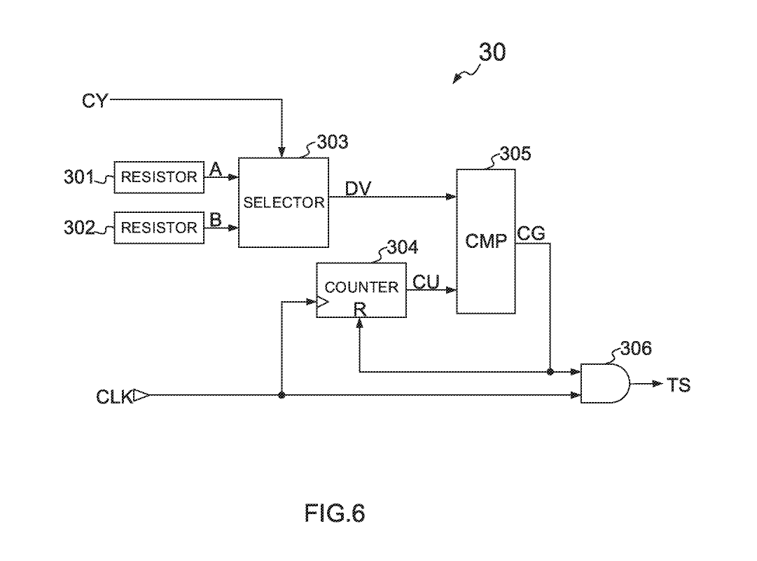

FIG. 5 is a circuit diagram of the LPF 15 when it comprises a digital-type transversal filter. FIG. 6 is a circuit diagram showing an example of the internal constitution of the passband setting part 30 when the digital-type transversal filter illustrated in FIG. 5 is adopted to the LPF 15.

The transversal filter which is illustrated in FIG. 5 includes n (n is an integer of 2 or more) flip flops FF1˜FFn connected in cascade, n coefficient multipliers M1˜Mn and an adder AD. The flip flops FF1˜FFn take in the frequency converted signal including the baseband signal BDI (BDQ) which is supplied from the mixer 14, while sequentially sifting at a timing of a leading edge of the passband setting signal TS. The coefficient multipliers M1˜Mn multiplies each of output signals from the flip flops FF1˜FFn by filter coefficients C1˜Cn. The adder AD obtains an addition result by adding multiplication results in the coefficient multipliers M1˜Mn. The adder AD outputs the addition result as the above high frequency noise eliminated signal BNI (BNQ).

The passband setting part 30 includes a resistor 301, 302, a selector 303, a counter 304, a comparator 305 and an AND gate 306.

The resistor 301 stores, in advance, fixed count value A for setting a high frequency clock. The resistor 301 supplies the comparator 305 with the fixed count value A. The resistor 302 stores, in advance, fixed count value B for setting a high frequency clock which is larger than the fixed count value A. The resistor 302 supplies he selector 303 with the fixed count value B.

The selector 303 selects one of the fixed count values A and B on the basis of the synchronization detection signal CY. The selector 303 supplies the comparator 305 with the selected one as the division value DV. The selector 303 selects the fixed count value A when the synchronization detection signal CY indicates logic level 0 as illustrated in FIG. 3C. The selector then supplies the comparator 305 with the fixed count value A as the division value DV. The selector selects the fixed count value B when the synchronization detection signal CY indicates logic level 1. The selector 303 then supplies the comparator 305 with the fixed count value B as the division value DV.

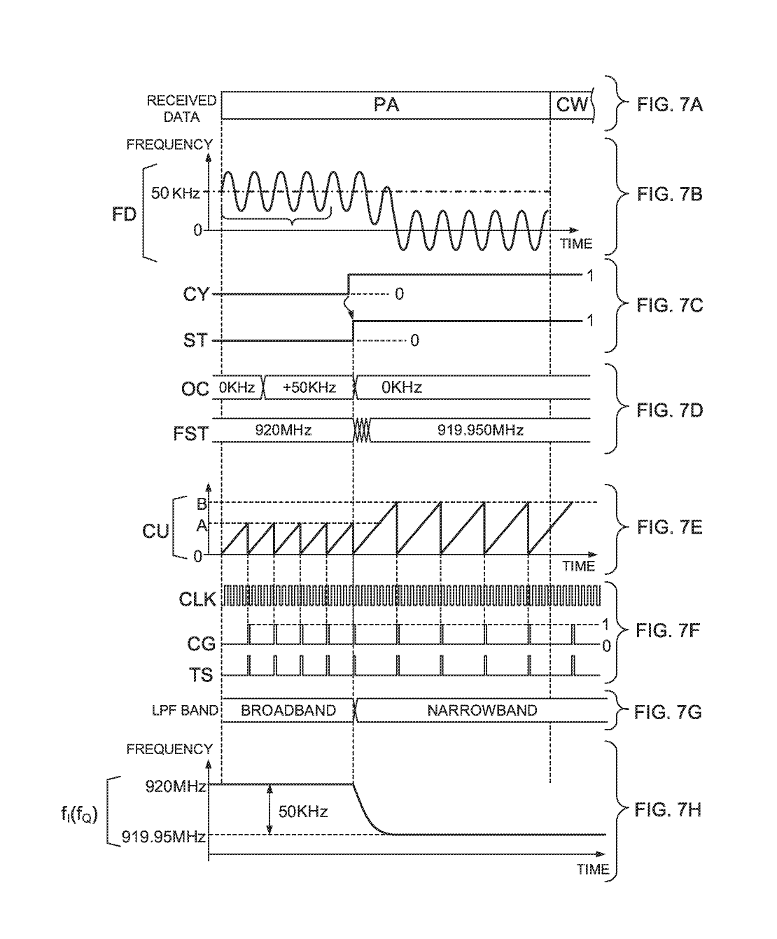

The counter 304 counts the number of the clock pulses of a master clock signal CLK which is illustrated in FIG. 7F. The counter 304 then supplies the comparator 305 with a count value CU which indicates the counted number. The master clock signal CLK may be the one generated in the oscillation circuit (not shown) provided in the receiving apparatus 100, or may be the one supplied from the outside of the receiving apparatus 100. The counter 304 once initialize the count value to zero at a timing synchronized with the master clock signal CLK when a clock gate signal CG which is kept at logic level 1 is supplied. The counter 304 then continues to count the number of the clock pulses of the master clock signal CLK.

The comparator 305 compares the count value CU which increases with the passage of time and the division value DV which indicates the above fixed count values A and B as illustrated in FIG. 7E. The comparator 305 supplies a reset terminal of the counter 304 and the AND gate 306 with the clock gate signal CG which is kept at logic level 0 when the count value CU and the division value DV are different from each other, and at logic level 1 when the count value CU matches the division value.

The AND gate 306 generates the passband setting signal TS of a clock signal form which is illustrated in FIG. 7F by outputting the master clock signal CLK during a period in which the clock gate signal CG is at logic level 1. The AND gate 306 then supplies clock terminals of each of the Flip Flops FF1˜FFn with the passband setting signal TS.

It is described below, with reference to FIGS. 7A-7H, operations of the LPF 15 and the passband setting part 30 to which configurations illustrated in FIG. 5 and FIG. 6 are adopted.

The comparator 305 illustrated in FIG. 6 compares the division value DV which indicates the fixed count value A for setting a high frequency clock and the count value CU of the number of pulses of the master clock signal CLK, when the synchronization detection signal CY is at logic level 0 as illustrated in FIG. 7C, i.e. when the synchronization signal is not yet detected. The comparator 305 generates the clock gate signal CG which is at logic level 1 when the division value DV matches the count value CU. The count value of the counter 304 is initialized to zero in response to the clock gate signal CG at logic level 1. One pulse of the clock signal in the master clock signal CLK is generated as the passband setting signal TS from the AND gate 306.

The passband setting part 30 generates the passband setting signal TS in the form of a clock signal having frequency corresponding to the fixed count value A during a period in which the synchronization detection signal CY is kept at logic level 0. The passband setting part 30 then supplies the clock terminal of each of the flip flop FF1˜FFn of the LPF 15 with the passband setting signal TS.

The comparator 305 compares the division value DV which indicates the fixed count value B for setting low frequency clock and the count value CU, when the synchronization signal is detected and the synchronization signal CY makes transition from logic level 0 to level 1 as illustrated in FIG. 7C. The comparator 305 generates the clock gate signal which is at logic level 1 when the division value DV matches the count value CV. The count value of the counter 304 is initialized to zero in response to the clock gate signal CG which is at logic level 1. One pulse of the clock signal in the master clock signal CLK is generated as the passband setting signal TS from the AND gate 306.

The passband setting part 30 generates the passband setting signal TS in the form of the clock signal having frequency corresponding to the fixed count value B during a period in which the synchronization detection signal CY is kept at logic level 1. The passband setting part 30 then supplies the clock terminal of each of the flip flop FF1˜FFn of the LPF 15 with the passband setting signal TS.

The fixed count value A is smaller than the fixed count value B. When the division value DV indicates the fixed count value A, the count value of the pulses of the master clock signal CLK reaches the division value DV in a shorter period than in the case the division value DV indicates the fixed count value B.

The frequency of the clock signals in the passband setting signal TS becomes higher in a period in which the fixed count value A is set as the division value DV than in a period in which the fixed count value B is set as the division value DV. In the LPF having the configuration of the digital-type transversal filter as illustrated in FIG. 5, the higher the frequency of the signal which is supplied to the clock terminal of each of the flip flops FF1˜FFn becomes, the broader the bandwidth of the passband becomes.

Therefore, it is possible to broaden the passband width of the LPF 15 during a period in which the synchronization detection signal CY is kept at logic level 0 and to narrow the passband width of the LPF 15 during a period in which the synchronization detection signal CY is kept at logic level 1, when the configurations which is illustrated in FIG. 5 and FIG. 6 are adopted to the LPF15 and the passband setting part 30.

In the configuration which is illustrated in FIG. 5 and FIG. 6, the passband setting part 30 controls the passband width of the LPF 15 by changing frequency of the passband setting signal TS as a clock signal. However, the passband setting part 30 may control the passband width of the LPF 15 by changing the filter coefficient C1˜Cn which is illustrated in FIG. 5. The passband setting part 30 stores in advance the filter coefficient C1˜Cn for obtaining the frequency characteristic L1 which is illustrated in FIG. 2 and the filter coefficient C1˜Cn for obtaining the frequency characteristic L2 which is broader than the frequency characteristic L1. The passband setting part 30 supplies each of the coefficient multipliers M1˜Mn in the LPF 15 with the passband setting signal TS which indicates the filter coefficient C1˜Cn for obtaining the frequency characteristic L2 during a period in which the synchronization detection signal CY is kept at logic level 0 as illustrated in FIG. 3C. The passband setting part 30 supplies each of the coefficient multipliers M1˜Mn in the LPF 15 with the passband setting signal TS which indicates the filter coefficient C1˜Cn for obtaining the frequency characteristic L1 which is narrower than the frequency characteristic L1, i.e. the upper limit of frequency of which is lower than that of the frequency characteristic L2, during a period in which the synchronization detection signal CY is kept at logic level 1.

The receiving apparatus 100 which is illustrated in FIG. 1 receives wireless transmission waves modulated in digital in FSK scheme as the reception target. However, the modulation scheme for receiving the wireless transmission waves is not limited to the FSK scheme. The receiving apparatus 100 which is illustrated in FIG. 1 may receive the wireless transmission waves modulated in digital modulation scheme including not only FSK but also ASK(amplitude shift keying), PSK(phase sift keying), QAK(quadrature amplitude modulation) and so on.

In the above example, the synchronization detector 21 generates the synchronization detection signal CY which is kept at logic level 0 during a period in which the synchronization signal is not detected and which is kept at logic level 1 after the synchronization signal is detected. However, the synchronization detector 21 may generate the synchronization detection signal CY which is kept at logic level 1 during a period in which the synchronization signal is not detected and which is kept at logic level 0 after the synchronization signal is detected.

In other words, receiving apparatus 100 may be for demodulating a received signal obtained by receiving a wireless transmission wave which is modulated according to a series of data sequences including frames each having a synchronization signal, comprising: frequency converting parts (12˜14), a filter (15), a frequency detector (16), a frequency offset detector (17), a frequency correction part (22), a synchronization detector (21) and a passband setting part (30). The frequency converting part performs a frequency conversion on the received signal (AR) and obtains a frequency converted signal including a baseband signal (BDI, BDQ). The filter eliminates high frequency noise components from the frequency converted signal and obtains a high frequency noise eliminated signal (BNI, BNQ). The frequency detector performs a frequency detection on the high frequency noise eliminated signal and obtains a frequency detection signal (FD). The frequency offset detector detects a frequency offset (OC) occurring in the frequency converted signal on the basis of the frequency detection signal. The frequency correction part sifts frequency of the frequency converted signal by the amount of the frequency offset. The synchronization detector detects the presence of the synchronization signal for each frame and generates a synchronization detection signal (CY) which has a first level as far as the synchronization signal is not detected and has a second level when and after the synchronization signal is detected. The passband setting part sets an upper limit of frequency of a passband in the filter at a lower frequency within a period in which the synchronization detection signal is kept at the second level than that within a period in which the synchronization detection signal is kept at the first level.

It is understood that the foregoing description and accompanying drawings set forth the preferred embodiments of the present invention at the present time. Various modifications, additions and alternative designs will, of course, become apparent to those skilled in the art in light of the foregoing teachings without departing from the spirit and scope of the disclosed invention. Thus, it should be appreciated that the present invention is not limited to the disclosed Examples but may be practiced within the full scope of the appended claims.

This application is based upon and claims the benefit of priority from the prior Japanese Patent Application No. 2015-015316 filed on Jan. 29, 2015, the entire contents of which are incorporated herein by reference.

What is claimed is:

1. A receiving apparatus for demodulating a received signal obtained by receiving a wireless transmission wave which is modulated according to a series of data sequences including frames each having a synchronization signal, the receiving apparatus comprising:
a frequency converting part for performing a frequency conversion on the received signal and obtaining a frequency converted signal including a baseband signal,
a filter for eliminating high frequency noise components from the frequency converted signal and obtaining a high frequency noise eliminated signal,
a frequency detector for performing a frequency detection on the high frequency noise eliminated signal and obtaining a frequency detection signal,
a frequency offset detector for detecting a frequency offset occurring in the frequency converted signal on the basis of the frequency detection signal,
a frequency correction part for sifting frequency of the frequency converted signal by the amount of the frequency offset,
a synchronization detector for detecting the presence of the synchronization signal in each of said frames, and generating a synchronization detection signal which has a first level as far as the synchronization signal is not detected and has a second level when and after the synchronization signal is detected; and
a passband setting part for setting an upper limit of frequency of a passband in the filter at a lower frequency within a time period in which the synchronization detection signal is kept at the second level than that within a time period in which the synchronization detection signal is kept at the first level.

2. The receiving apparatus according to claim 1, wherein said filter is a transversal filter including 1st to nth (where the n denotes an integer of 2 or more) flip flops connected in cascade, 1st to nth coefficient multipliers for multiplying outputs from the 1st to nth flip flops by 1st to nth filter coefficients, an adder for outputting the addition result obtained by adding the multiplication results of each of the coefficient multipliers as the high frequency noise eliminated signal,
wherein said passband setting part supplies each of the 1st to nth flip flops with a low frequency clock signal when the synchronization signal makes transition from the first level to the second level in each of said frames.

3. The receiving apparatus according to claim 1, wherein said filter is a low pass filter including a transversal filter,
wherein said passband setting part changes filter coefficients in said transversal filter when the synchronization signal makes transition from the first level to the second level in each of said frames.

4. A receiving method for a receiving apparatus comprising a frequency converting part for performing a frequency conversion on the received signal and obtaining a frequency converted signal including a baseband signal, a filter for eliminating high frequency noise components from the frequency converted signal and obtaining a high frequency noise eliminated signal, a frequency detector for performing a frequency detection on the high frequency noise eliminated signal and obtaining a frequency detection signal, and a frequency offset detector for detecting a frequency offset occurring in the frequency converted signal on the basis of the frequency detection signal, the receiving method comprising the steps of:
detecting the presence of the synchronization signal in each frame, and generating a synchronization detection signal which has a first level as far as the synchronization signal is not detected and has a second level when and after the synchronization signal is detected,
setting an upper limit of frequency of a passband in the filter at lower frequency within a time period in which the synchronization detection signal is kept at the second level than that within a time period in which the synchronization detection signal is kept at the first level.
